(19) United States
(12) Patent Application Publication
(10) Pub. No.: US 2002/0137865 A1
(43) Pub. Date: Sep. 26, 2002

(54) Branched polymers containing imidazole groups and the production and use thereof

(75) Inventors: Karlheinz Haubennestel, Wesel (DE); Ulrich Orth, Wesel (DE); Udo Krappe, Wesel (DE); Ulrich Gajewiak, Dinslaken (DE)

Correspondence Address: SCHWEGMAN, LUNDBERG, WOESSNER & KLUTH, P.A., P.O. BOX 2938, MINNEAPOLIS, MN, 55402, US

(73) Assignee: BYK-Chemie GmbH

(21) Appl. No.: 10/010,433

(22) Filed: Dec. 7, 2001

Related U.S. Application Data
(63) Continuation of application No. 09/640,221, filed on Aug. 16, 2000, now abandoned.

(30) Foreign Application Priority Data
Aug. 28, 1999 (DE) 199 41 031.3

(51) Int. Cl. C08F 234/00

(52) U.S. Cl. 526/258; 526/333

(57) ABSTRACT

The invention relates to branched polymers derived by free-radical polymerisation from a mixture of monomers with 50 to 93 wt. % of at least one ethylenically unsaturated monomer, 2 to 25 wt. % of at least one ethylenically unsaturated macromonomer with a molecular weight of 1,000 to 20,000 and 5 to 25 wt. % of at least one polymerisable imidazole derivative, wherein the components together make up 100 wt. %, the resulting polymer possesses a molecular weight of 15,000 to 100,000 and is optionally present in the form of a salt. The present invention also relates to the production of these polymers and their use as dispersing agents in liquid media or for the pre-coating of solids to be dispersed.

The invention relates to branched polymers which contain imidazole groups in the backbone-polymer. The invention further relates to a process for the production of these polymers and their use as dispersing agents for organic and inorganic pigments or fillers in organic and aqueous systems.

In order to be able to introduce solids into liquid media, high mechanical forces are needed. It is conventional to use dispersing agents to reduce these dispersing forces and to keep the total energy input into the system needed for the deflocculation of the solid particles, and thus also the dispersing time, as low as possible. These dispersing agents are surface-active substances of anionic, cationic or neutral structure. Small quantities of these substances are either applied to the solid directly or added to the dispersing medium. It is also known that, even after the complete deflocculation of the solid agglomerates into primary particles, reagglomerations occur after the dispersing process, as a result of which part or all of the dispersing input is wasted. As a consequence of inadequate dispersion or of reagglomeration, undesirable effects occur, such as e.g. increased viscosity in liquid systems, colour drift and reductions in gloss in paints and coatings, and a reduction in mechanical strength in plastics.

Many different substances are used as dispersing agents for pigments and fillers today. An overview of the prior art relating to this can be found in EP 0 318 999 (page 2, lines 24-26). In addition to simple, low molecular-weight compounds, such as e.g. lecithin, fatty acids and salts thereof and alkyl phenol ethoxylates, complex structures are also used as dispersing agents. These are especially amino- and amide-functional systems, which are widely used among the dispersing agents. In GB 2 153 804, for example, amino- and amide-functional poly- and oligocopolymers based on (poly)amines and polycaprolactones are used for dispersing magnetic pigments. EP 0 713 894 describes the use of aminofunctional polylactones for coatings and printing inks. In addition, EP 0 311 157 and U.S. Pat. No. 3,980,602 describe the use of amine-functional polyacrylates for stabilising organic and inorganic pigments. Another group of dispersing agents is represented by amine-functional polymers based on polyisocyanates, as described in EP 0 159 678 and EP 0 438 836. Amine-functional polymers with a proportion of macromonomers are disclosed in EP 732 346.

Many of these dispersing agents, while having adequate pigment- or solids-stabilising properties, display an inadequate ability to reduce the viscosity when pigments or solid particles are being incorporated into binders and pigment concentrates. As efforts to produce environmentally compatible systems progress, there is a need to reduce the amount of solvents as far as possible (e.g. high-solid and ultra-high-solid paints), or to omit solvents altogether. This generally leads to production problems, as the viscosity is often too high when incorporating or dispersing the solid particles. This applies in particular to the production of pigment concentrates, in which the highest possible pigment content should be achieved with, at the same time, a small proportion of binder or solvent.

Pigment pastes only display their full benefit when they can be used as universally as possible, i.e. in many different binders which often vary widely in their polarity. With the dispersing agents used up to the present, precisely this broad compatibility of pigment pastes is not guaranteed, so that the use of paste systems is considerably restricted. In addition to the use of pigment pastes in different binders, it must also be guaranteed that the pastes are miscible with one another, and in the binder, without flocculation.

The above dispersing agents often represent only partial solutions to this problem. Owing to the large number of inorganic and organic pigments and fillers used today, adequate stabilisation of the solid particles to be dispersed is not sufficiently guaranteed by a desorption-stable coating of the surface. Agglomerations therefore occur, since the efficient steric hindrance needed is lacking.

It is known that polyacrylates with acidic and basic groups, which can also be in the form of salts, are used as dispersing agents. These products are prepared, for example, by polymerising appropriate monomeric acrylates in combination with styrene, acrylic acid and dimethylaminoethyl methacrylate. Other monomers with ethylenic double bonds can also be used in the polymerisation for these polymers, such as e.g. vinylpyridine, vinylimidazole and alkyl vinyl ether as described in EP O 311 157 and U.S. Pat. No. 3,980,602.

However, it has already been suggested in U.S. Pat. Nos. 5,770,646, 5,608,025, EP 0 781 820 and U.S. Pat. No. 5,714,538 to incorporate ethylenically unsaturated macromonomers in the copolymerisation in combination with other polymerisable monomers, such as e.g. acrylic acid and dimethylaminoethyl methacrylate.

The present invention was based on the object of, on the one hand, developing dispersing additives which enable pigment concentrates to be produced which possess the lowest possible viscosity with the highest possible pigment concentration and which, on the other hand, keep the viscosity of pigment concentrates stable over a long period and enable mixtures of these pigment concentrates with other pigment concentrates to display no colour differences in the “rub-out” test.

Surprisingly, it has been shown that branched polymers made of ethylenically unsaturated monomers and vinylimidazole in the backbone-polymer and ethylenically unsaturated macromonomers as side chains achieve these objects.

In order to produce the dispersing agents according to the invention, ethylenically unsaturated monomers, ethylenically unsaturated macromonomers with molecular weights (MW) of 1000-20000, preferably 5000-10000, and monomers containing imidazole groups are copolymerised by known processes, preferably by free-radical polymerisation.

As ethylenically unsaturated compounds for the production of the parent polymer, e.g. acrylates and/or methacrylates of straight-chain or branched alcohols with 1-22 C atoms, such as methyl (meth)acrylate, ethyl (meth)acrylate, n-, i- and t-butyl (meth)acrylate, lauryl (meth)acrylate, 2-ethylhexyl (meth)acrylate, stearyl (meth)acrylate or behenyl (meth)acrylate are used. Cycloaliphatic (meth)acrylates, such as e.g. cyclohexyl (meth)acrylate and isobornyl (meth)acrylate, can also be used. Aralkyl (meth)acrylates, such as benzyl (meth)acrylate, are also suitable. (Meth)acrylates with a hydroxy function can also be incorporated as comonomers in the production of the parent polymer, e.g. in order to make it possible for the dispersing agent to cross-link with the binder in which it is later to be used. Such hydroxy esters are, e.g., hydroxyethyl (meth)acrylate and hydroxypropyl (meth)acrylate. Other suitable ethylenically unsaturated comonomers are, e.g., styrene, α-methylstyrene, triethylene glycol mono(meth)acrylate, acrylonitrile, methoxypolyethylene glycol (meth)acrylate, butoxypropylene glycol (meth)acrylate, ethyl vinyl ether, butyl vinyl ether and cyclohexyl vinyl ether.

The above-mentioned ethylenically unsaturated monomers are polymerised individually or in combination, depending on the desired binder compatibility.

However, the additional incorporation of imidazole groups in the parent polymer, in quantities of 5 to 25 wt. %, preferably 10 to 20 wt. %, is essential for the invention here. Vinylimidazole is preferred as the monomer containing imidazole groups.

The macromonomers serving as side chains can be prepared by known methods, as described e.g. in U.S. Pat. Nos. 5,770,646, 5,310,813, Russian Chemical Reviews, 56 (8), 1987 and XXIV International Conference in Organic Coatings, Jul. 6-10, 1998, Application of Graft Copolymers by Macromonomer method to 2-component polyurethane coatings (Kansai Paint Co. Ltd.).

(Meth)acrylates of straight-chain or branched alcohols with 1-22 C atoms, such as methyl (meth)acrylate, ethyl (meth)acrylate, n-, i- and t-butyl (meth)acrylate, lauryl (meth)acrylate, 2-ethylhexyl (meth)acrylate, stearyl (meth)acrylate or behenyl (meth)acrylate, are suitable for the preparation of the macromonomers. Cycloaliphatic (meth)acrylates, such as e.g. cyclohexyl (meth)acrylate and isobornyl (meth)acrylate, can also be used. Benzyl (meth)acrylate is also suitable. Other suitable monomers are, e.g., styrene, α-methylstyrene, acrylonitrile and alkyl vinyl ethers, as already mentioned above. However, mixtures of these monomers can also be used.

In addition to the poly(meth)acrylates with terminal (meth)acrylic function, however, other macromonomers are also suitable as comonomers. The monovinyl-terminated polydimethyl-siloxanes, which are obtained, for example, by reacting monohydroxyfunctional polysiloxanes (obtainable e.g. from Shin Etsu) with (meth)acrylic acid, are preferred.

In order to ensure that these macromonomers substantially contain only one ethylenically unsaturated end group, special processes are required for their synthesis. On the one hand they can be prepared with the aid of so-called “chain transfer agents”, as described in U.S. Pat. No. 5,770,646. For this purpose, cobalt complexes are used in concentrations of 5-1000 ppm. Pentacyanocobaltate(II) or diaquabis(boron difluorodimethyl-phenylglyoximato)cobaltate(II), for example, are preferred. The corresponding Co(III) complexes

are equally used. The polymerisation can then be performed in solvents, such as e.g. aromatics, ketones, acetates, alcohols or glycol ethers. The peroxo and/or azo initiators which are known to the skilled person can be used as radical-forming initiators. On the other hand these macromonomers can be prepared by free-radical polymerisation in the presence of a mercaptofunctional carboxylic acid as chain regulator, such as e.g. mercaptoacetic acid or mercaptopropionic acid. This terminal carboxyl function is further reacted with glycidyl methacrylate to form the methacrylic functional, polymerisable macromonomer.

Hydroxyfunctional chain regulators, such as e.g. mercaptoethanol or mercaptopropanol, can also be used. The polymers obtained using these agents then have a hydroxy function at the end which is further reacted with (meth)acryloyl chloride to form the (meth)acrylic functional, polymerisable macromonomer.

The detailed preparation of the macromonomers is described in the above-mentioned patent specifications.

These macromonomers are used in the branched polymers according to the invention in quantities of 2-25 wt. %, preferably 5-15 wt. %.

As a result of using these macromonomers in the copolymers according to the invention, block structures can, in a sense, be produced if different monomers/monomer mixtures are used in the parent polymer and in the macromer. These block structures can otherwise only be obtained by using special polymerisation processes, such as e.g. group transfer polymerisation.

By selecting specific monomers in the backbone-polymer, and also in the macromonomer, the compatibility of the polymers according to the invention with binders or solvents can optionally be adapted, thus achieving an optimum spectrum of effectivity.

The molecular weights of the branched polymers according to the invention are in the range of 15,000-100,000, preferably 25,000-75,000, particularly preferably in the range of 30,000 50,000.

The imidazole groups of the branched polymers according to the invention can also be in the form of salts. Monocarboxylic acids, such as e.g. acetic acid, propionic acid, stearic acid, oleic acid, hydroxycarboxylic acids, such as e.g. ricinoleic fatty acid, hydroxystearic acid, sulfonic acids of the general formula HOSO₂R¹, sulfates of the general formula HOSO₃R¹, polyoxyalkylene glycol monoalkyl ether mono/di-phosphates and phosphates of the general formula (OH)₃₋ₙPO(OR²)ₙ with n=1 or 2 as described in EP 0 417 490, and inorganic acids, such as e.g. phosphoric acid, are used as salt-forming components.

The radicals R¹ and R² are characterised in that they contain at least one alkyl, aryl or aralkyl radical with more than 5 carbon atoms and/or a carboxylate function (—COO—) and/or a urethane group (—NHCOO—).

The polymers according to the invention with side chains are prepared in a manner known to the skilled person by means of free-radical polymerisation in organic solvents using radical formers (initiators), such as e.g. peroxides or azo compounds.

Suitable solvents are esters, such as e.g. ethyl acetate, n-butyl acetate or 1-methoxy-2-propyl acetate, and alcohols, such as e.g. ethanol, i-propanol, n-butanol or 1-methoxy-2-propanol. Aromatic solvents, such as e.g. toluene, xylene or higher-boiling alkylbenzenes, can also be used. The use of other solvents or the use of solvent mixtures is also conceivable, the choice of solvent or solvents being dependent on the end use of the copolymer according to the invention. Esters are preferably used, 1-methoxy-2-propyl acetate being particularly preferred.

Suitable initiators are, for example, peroxides, such as tert.-butyl peroxybenzoate or dibenzoyl peroxide. However, for example, azo compounds such as azoisobutyronitrile (AIBN) can also be used. Peroxides are preferably used, particularly preferably tert.-butyl peroxybenzoate.

The polymerisation is carried out at temperatures of approx. 50° C. to 180° C., preferably at 90° C. to 150° C., particularly preferably at 110° C. to 130° C.

The area of application of the dispersing agents according to the invention covers the areas of application known from the prior art. Thus, for example, the dispersing agents according to the invention can be used in the production of paints, pastes and/or moulding compositions containing pigments and/or fillers. The dispersing agents can be used alone or in combination with binders. In addition to the use of the reaction products according to the invention as dispersing agents in liquid phases, this invention also provides the coating of powdered or fibrous solids with the

polymers according to the invention. These coatings of organic and also inorganic solids are carried out by known means, as described e.g. in EP-A-0 270 126. The pigments pre-treated in this way are easier to incorporate in the binder and by improved viscosity, flocculation and gloss behaviour compared with untreated pigments.

The dispersing agents according to the invention are generally used in a quantity of 0.5 to 100 wt. %, based on the solid to be dispersed. To disperse special solids, however, it is entirely possible that substantially greater quantities of the dispersing agents may be needed.

The quantity of dispersing agent is substantially dependent on the surface to be coated of the solid to be dispersed. Carbon black, for example, requires substantially greater quantities of dispersing agent than, for example, TiO₂. Examples of pigments or fillers are found in EP-A-0 270 126. In addition, mineral fillers, e.g. calcium carbonate, calcium oxide, but also flame retardants, such as e.g. aluminium hydroxide or magnesium hydroxide, can also be dispersed.

The invention is additionally explained by the following examples. In the case of substances with non-uniform molecular structures, the molecular weights given represent averages of the number average, determined by gel permeation chromatography with PMMA as standard.

Unless stated otherwise, parts are parts by weight and percentages are percent by weight.

The methacrylate functional macromonomers were prepared by the same method described below. The preparation of the

methacrylate functional poly-n-butyl methacrylate is described by way of an example.

The following abbreviations are used:

BMA: butyl methacrylate

BA: butyl acrylate

PMA: propylene glycol monomethyl ether acetate

HEMA: hydroxyethyl methacrylate

BZMA: benzyl methacrylate

2EHA: 2-ethylhexyl acrylate

DMAEMA: dimethylaminoethyl methacrylate

VI: vinylimidazole

AI: allylimidazole

### PREPARATION EXAMPLES

Preparation of a poly-n-butyl Acrylate Macromonomer (According to U.S. Pat. No. 5,310,813)

86.5 parts n-butyl acetate are placed in a flask with a reflux condenser, thermometer, stirrer, gas inlet tube and dropping funnel and heated to reflux under a nitrogen atmosphere. A mixture of 80 parts BA, 4.5 parts mercaptopropionic acid as chain regulator and 2 parts tert.-butyl peroxybenzoate as polymerisation initiator are added within 3 hours under reflux. When the addition is complete, the reaction is performed for a further 2 hours. A polymer with terminal carboxyl function is obtained. The reaction mixture is cooled to 90° C. and 200 ppm hydroquinone monomethyl ether are added as polymerisation inhibitor. 12 parts glycidyl methacrylate are then added and the mixture is maintained at 90° C. for a further 6 hours. The polymer prepared in this way contains a terminal methacrylic function which is capable of further polymerisation.

The macromonomers described in the following table are produced in the same way with glycidyl methacrylate.

| | |
|---|---|
| Macromonomer 1 | styrene/acrylonitrile 3:1 (MW: approx. |
| | 6000) |
| Macromonomer 2 | poly-n-butyl acrylate (MW: approx. 6000) |
| Macromonomer 3 | butyl methacrylate/hydroxyethyl |
| | methacrylate 1:1 (MW: approx. 7000) |

The methacrylic functional polydimethylsiloxane is prepared by reacting a monohydroxyfunctional polydimethylsiloxane with methacrylic acid.

| | |
|---|---|
| Macromonomer 4 | polydimethylsiloxane (MW: approx. 30000) |
| Macromonomer 5 | polydimethylsiloxane (MW: approx. 6000) |

General Preparation of the Polymers:

### Examples 1-18 Comparative Examples 1+2

100 g propylene glycol monomethyl ether acetate are heated to 125° C., stirring. The monomer mixture according to example 1-18, and 1.5 g tert.-butyl peroxybenzoate are added dropwise to the initial propylene glycol monomethyl ether acetate within 90 minutes and stirring is continued for a further 5 h. The reaction is then complete.

Examples 1-18:

| | | | | Poly- |
|---|---|---|---|---|
| | Monomers/ | Macro- | Molecular | dispersity |
| | wt. % | monomer | wt. (Mn) | (Mw/Mn) |
| Comp. | BMA/85% | macro- | 33,400 | 6.3 |
| example 1 | DMAEMA/l0% | monomer 1 | | |
| | | 5% | | |
| Comp. | BMA/90% | — | 31,200 | 5.9 |
| example 2 | VI/10% | | | |
| Example 1 | BMA/85% | macro- | 31,600 | 7.5 |
| | VI/10% | monomer 2 | | |
| | | 5% | | |
| Example 2 | BMA/85% | macro- | 29,850 | 6.2 |
| | VI/10% | monomer 3 | | |
| | | 5% | | |
| Example 3 | BMA/85% | macro- | 36,200 | 9.1 |
| | VI/10% | monomer 1 | | |
| | | 5% | | |
| Example 4 | BMA/75% | macro- | 29,850 | 6.2 |
| | VI/10% | monomer 1 | | |
| | HEMA/10% | 5% | | |
| Example 5 | BMA/75% | macro- | 40,100 | 5.6 |
| | VI/10% | monomer 2 | | |
| | HEMA/10% | 5% | | |
| Example 6 | BMA/78% | macro- | 29,850 | 6.2 |
| | VI/10% | monomer 1 | | |
| | HEMA/10% | 2% | | |
| Example 7 | BMA/85% | macro- | 37,600 | 7.5 |
| | VI/10% | monomer 2 | | |
| | | 5% | | |
| Example 8 | BMA/56.7% | macro- | 32,750 | 6.8 |
| | VI/10% | monomer 1 | | |
| | EHA/28.3% | 5% | | |
| Example 10 | BMA/85% | macro- | 33,900 | 8.1 |
| | VI/10% | monomer 4 | | |
| | | 5% | | |
| Example 11 | BMA/80% | macro- | 45,350 | 8.6 |
| | VI/10% | monomer 1 | | |
| | | 10% | | |
| Example 12 | BMA/65% | macro- | 5,580 | 9.2 |
| | VI/10% | monomer 1 | | |
| | | 25% | | |
| Example 13 | BMA/70% | macro- | 32,100 | 8.4 |
| | VI/15% | monomer 1 | | |
| | HEMA/10% | 5% | | |
| Example 14 | BMA/75% | macro- | 35,200 | 9.2 |
| | VI/20% | monomer 1 | | |
| | | 5% | | |
| Example 15 | BMA/85% | macro- | 36,900 | 8.2 |
| | VI/10% | monomer 5 | | |
| | | 5% | | |
| Example 16 | BA/60% | macro- | 45,250 | 9.3 |
| | VI/25% | monomer 2 | | |
| | | 15% | | |
| Example 17 | EHA/75% | macro- | 38,500 | 7.6 |
| | VI/20% | monomer 1 | | |
| | | 5% | | |
| Example 18 | BMA/80% | macro- | 42,300 | 8.8 |
| | AI/10% | monomer 2 | | |
| | | 10% | | |

### APPLICATION EXAMPLES

To evaluate the compounds according to the invention, pigment concentrates were prepared without any additional binder and the pigment stabilisation was evaluated in a white mix using the “rub-out” value as AE. This involves evaluating colour differences brought about by inadequate pigment stabilisation. The lower the ΔE value, the better the pigment stabilisation of the mix.

To prepare the pigment pastes, the raw materials and the glass beads needed for grinding are weighed, sucdessively, into a 500 ml metal vessel and then dispersed with a 40 mm Teflon disk at 40° C.

The dispersed pastes are sieved through a paper sieve (mesh size 80 μm) and poured into glass bottles. Free-flowing pigment pastes are obtained with very good rheological properties.

| Paste | | | Heliogen | Special |
|---|---|---|---|---|
| formula- | | Bayferrox | Blue | Black |
| tions: | TiO2 2160 | 130M | L 7101 F | 4 |
| PMA | 29.5 | 27.6 | 70.0 | 57.5 |
| 50% | 5.2 | 12.0 | 10.0 | 17.5 |
| additive | | | | |
| Aerosil 200 | 0.3 | 0.4 | — | — |
| Pigment | 65.0 | 60.0 | 20.0 | 25.0 |
| | 100.0 | 100.0 | 100.0 | 100.0 |

Pigment dispersions:

| | | | | |
|---|---|---|---|---|
| TiO2 2160: | 30 min | 8000 rpm | 40° C. beads | 2 mm 1:1 |
| 130 M: | 40 min | 8000 rpm | 40° C. beads | 1 mm 1:1 |
| L 7101 F: | 40 min | 10000 rpm | 40° C. beads | 1 mm 1:1 |
| SS 4: | 60 min | 10000 rpm | 40° C. beads | 1 mm 1:1 |

Clear lacquer formulations:

| 2-pack acrylate: | |
|---|---|
| Macrynal SM | 75.0 |
| 510 | |
| (Hoechst) | |
| PMA | 5.0 |
| Solvesso 100 | 5.0 |
| Xylene | 6.4 |
| Butyl acetate | 8.0 |
| Byk 306 | 0.1 |
| Byk 066 | 0.5 |
| Hardener solution | |
| Desmodur N | 50.0 |
| 3390 | |
| (Bayer) | |
| Xylene | 35.0 |
| Butyl acetate | 15.0 |

Clear Lacquer:Hardener Solution 2:1

| | | | | |
|---|---|---|---|---|
| Coating: | clear lacquer | 69.3 | 64.7 | 68.4 |
| | white paste | 30.7 | 28.6 | 30.3 |
| | coloured paste | — | 6.7 | — |
| | black paste | — | — | 1.3 |
| | | 100.0 | 100.0 | 100.0 |

2-pack acrylate system: SM510/N3390:

| | Heliogen Blue | Bayferrox | Special black |
|---|---|---|---|
| | L 7101F | 130M | 4 |
| | (ΔE) | (ΔE) | (ΔE) |
| Example 3 | 1.8 | 0.2 | 0.5 |
| Example 7 | 1.9 | 0.5 | 0.6 |
| Example 8 | 1.9 | 0.4 | 0.5 |
| Example 9 | 1.8 | 0.4 | 0.5 |
| Comp. example | 2.2 | 2.2 | 1.3 |
| 1 | | | |
| Comp. example | 2.1 | 0.7 | 1.2 |
| 2 | | | |

1. Branched polymer, characterised in that it is derived from the following mixture of monomers:
(A) 50 to 93 wt. % of at least one ethylenically unsaturated monomer,
(B) 2 to 25 wt. % of at least one ethylenically unsaturated macromonomer with a molecular weight of 1,000 to 20,000 and
(C) 5 to 25 wt. % of at least one polymerisable imidazole derivative,
wherein components (A), (B) and (C) together make up 100 wt. %, the polymer possesses a molecular weight of 15,000 to 100,000 and is optionally present in the form of a salt.

2. Branched polymer according to claim 1, wherein component (B) is present in a quantity of 5 to 15 wt. % and component (C) in a quantity of 10 to 20 wt. %.

3. Branched polymer according to one or more of claims 1 and 2, wherein the molecular weight of the polymer is 25,000 to 75,000, preferably 30,000 to 50,000.

4. Branched polymer according to one or more of claims 1 to 3, wherein component (A) is optionally a hydroxyalkyl or an alkyl polyalkylene glycol acrylate or methacrylate, a styrene or derivative thereof or a vinyl ether and component (B) is a poly(meth)acrylate with terminal (meth)acrylic function or a monovinyl-terminated polydimethylsiloxane and component (C) is N-vinylimidazole.

5. Branched polymer according to one or more of claims 1 to 4, wherein this is present as a salt of a fatty acid, a hydroxycarboxylic acid, a sulfonic acid, a sulfate, an acidic phosphate or an inorganic acid.

6. Process for the production of a branched polymer, characterised in that
(A) 50 to 93 wt. % of at least one ethylenically unsaturated monomer,
(B) 2 to 25 wt. % of at least one ethylenically unsaturated macromonomer with a molecular weight of 1,000 to 20,000 and
(C) 5 to 25 wt. % of at least one polymerisable imidazole derivative are polymerised by free-radical polymerisation in the presence of an organic solvent and at least one radical initiator, at a temperature of 50 to 180° C., and the polymer thus obtained is optionally converted to its salt.

7. Process according to claim 6, characterised in that the organic solvent is an ester and the radical initiator is a peroxide or an azo compound.

8. Process according to one or more of claims 6 and 7, characterised in that the reaction temperature is 90 to 150° C.

9. Use of the polymers from one or more of claims 1 to 5 as dispersing agents for the production of paints and/or pastes and/or moulding compositions containing pigments and/or fillers, optionally in combination with binders.

10. Use of the polymers from one or more of claims 1 to 5 for the coating of powdered or fibrous solids.

11. Use according to one or more of claims 9 and 10, characterised in that the branched polymer is used in a quantity of 0.5 to 100 wt. %, based on the solid to be dispersed.
